(19) United States
(12) Patent Application Publication
(10) Pub. No.: US 2023/0225419 A1
(43) Pub. Date: Jul. 20, 2023

(54) CHIP FOR VAPORIZER, VAPORIZER, AND ELECTRONIC VAPORIZATION DEVICE

(71) Applicant: SHENZHEN SMOORE TECHNOLOGY LIMITED, Shenzhen (CN)

(72) Inventors: Bosong ZHAO, Shenzhen (CN); Wenjie DONG, Shenzhen (CN); Qingliang ZHOU, Shenzhen (CN); Weiming FANG, Shenzhen (CN)

(21) Appl. No.: 18/188,376

(22) Filed: Mar. 22, 2023

Related U.S. Application Data
(63) Continuation of application No. PCT/CN2020/117848, filed on Sep. 25, 2020.

(51) Int. Cl. A24F 40/53; A24F 40/57; A24F 40/40

(52) U.S. Cl. CPC A24F 40/53; A24F 40/40; A24F 40/57; A24F 40/51

(57) ABSTRACT

A chip for a vaporizer includes: a package having a communication interface for determining whether a battery rod into which the vaporizer is inserted communicates with the vaporizer. When the battery rod communicates with the vaporizer, the vaporizer operates in a first mode. When the battery rod does not communicate with the vaporizer, the vaporizer operates in a second mode.

### CROSS-REFERENCE TO PRIOR APPLICATION

This application is a continuation of International Patent Application No. PCT/CN2020/117848, filed on Sep. 25, 2020. The entire disclosure is hereby incorporated by reference herein.

### FIELD

This application relates to the field of electronic vaporization devices, and in particular, to a chip for a vaporizer, a vaporizer, and an electronic vaporization device.

### BACKGROUND

At present, a memory chip is configured in a vaporizer of some electronic vaporization devices with encryption functions, and the password in the memory chip is used for encryption and identification. Although this method realizes the identification of the vaporizer by a battery rod in the electronic vaporization device, it has a single usage and cannot meet the requirements of different customers for different vaporizers.

### SUMMARY

In an embodiment, the present invention provides a chip for a vaporizer, comprising: a package comprising a communication interface configured to determine whether a battery rod into which the vaporizer is inserted communicates with the vaporizer, wherein, when the battery rod communicates with the vaporizer, the vaporizer is configured to operate in a first mode, and wherein, when the battery rod does not communicate with the vaporizer, the vaporizer is configured to operate in a second mode.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a first embodiment of a chip used for a vaporizer according to this application;

FIG. 2 is a schematic structural diagram of a second embodiment of a chip used for a vaporizer according to this application;

FIG. 3 is a schematic structural diagram of a first embodiment of a vaporizer according to this application;

FIG. 4 is a schematic structural diagram of a second embodiment of a vaporizer according to this application;

FIG. 5 is a schematic structural diagram of a third embodiment of a vaporizer according to this application;

FIG. 6 is a schematic structural diagram of a fourth embodiment of a vaporizer according to this application;

FIG. 7 is a schematic diagram of functional modules of a battery rod according to this application;

FIG. 8 is a schematic diagram of functional modules of a specific embodiment of FIG. 7;

FIG. 9 is a schematic diagram of a circuit structure of an embodiment of FIG. 8;

FIG. 10 is a schematic diagram of functional modules of another specific embodiment of FIG. 7;

FIG. 11 is a schematic diagram of a circuit structure of an embodiment of FIG. 10;

FIG. 12 is a schematic structural diagram of an embodiment of an electronic vaporization device formed by forwardly inserting the vaporizer shown in FIG. 3 in the battery rod shown in FIG. 9;

FIG. 13 is a schematic structural diagram of an embodiment of an electronic vaporization device formed by reversely inserting the vaporizer shown in FIG. 3 in the battery rod shown in FIG. 9;

FIG. 14 is a schematic structural diagram of a fifth embodiment of a vaporizer according to this application;

FIG. 15 is a schematic diagram of functional modules of a second embodiment of a battery rod according to this application;

FIG. 16 is a schematic flowchart of a first embodiment of a method of using an electronic vaporization device according to this application; and

FIG. 17 is a schematic flowchart of a second embodiment of a method of using an electronic vaporization device according to this application.

### DETAILED DESCRIPTION

In an embodiment, the present invention provides a chip for a vaporizer, a vaporizer, and an electronic vaporization device, to meet requirements of use in different environments.

In an embodiment, the present invention provides a chip for a vaporizer, including: a package, where the package is provided with a communication interface, so that when the vaporizer is inserted in a battery rod, whether the battery rod communicates with the vaporizer is determined through the communication interface; when the battery rod communicates with the vaporizer, the vaporizer operates in a first mode; and when the battery rod does not communicate with the vaporizer, the vaporizer operates in a second mode.

The chip further includes: a control switch, arranged in the package; and a driving control circuit, arranged in the package, where a control end of the driving control circuit is connected to a control end of the control switch, and a communication end of the driving control circuit is connected to the communication interface, to determine whether the battery rod communicates with the vaporizer through the communication interface.

The package further includes a switch channel interface, a ground interface, and a power supply interface, where the switch channel interface is connected to a first channel end of the control switch; the ground interface is connected to a second channel end of the control switch and a ground end of the driving control circuit; and the power supply interface is connected to a power supply end of the driving control circuit, and connected to the communication interface.

The package further includes a switch control interface and/or an expansion interface, where the switch control interface is further connected to the control end of the control switch, and the expansion interface serves as a reserved interface of the chip.

The package further includes: a diode, arranged in the package, wherein the communication interface is connected to the power supply interface through the diode.

The package further includes: a resistor, arranged in the package, wherein the communication interface is connected to the ground interface through the resistor.

The driving control circuit includes a memory storing preset data, when the vaporizer is inserted in the battery rod and the battery rod does not communicate with the vaporizer within a predetermined time period, the driving control circuit controls the control switch according to the preset data, to cause the vaporizer to operate in the second mode.

To resolve the foregoing technical problem, the second technical solution provided in this application is as follows: A vaporizer is provided, including: a heating element; and a chip, connected to the heating element, where the chip is the chip according to any one of the foregoing; and after the vaporizer is inserted in the battery rod, when the battery rod communicates with the vaporizer, the chip controls the heating element to cause the vaporizer to operate in the first mode, and when the battery rod does not communicate with the vaporizer, the chip controls the heating element to cause the vaporizer to operate in the second mode.

The vaporizer further includes: a first input end and a second input end, where when the vaporizer is inserted in the battery rod, the vaporizer is electrically connected to the battery rod through the first input end and the second input end, the heating element and the control switch of the chip are connected in series between the first input end and the second input end, and the communication interface of the package is connected to the first input end; and a capacitor, where the power supply interface of the package is grounded through the capacitor.

The vaporizer further includes: a first switch, where a control end of the first switch is connected to the switch control interface, a first channel end of the first switch is connected to the switch channel interface, and a second channel end of the first switch is connected to the ground interface, so that the first switch is connected in parallel to the control switch.

The vaporizer further includes: a second switch, where a control end of the second switch is connected to the switch control interface, a first channel end of the second switch is connected to the ground interface, and a second channel end of the second switch is connected to the second input end, so that the heating element, the control switch, and the second switch are connected in series between the first input end and the second input end in sequence.

The vaporizer further includes: a first input end and a second input end, where when the vaporizer is inserted in the battery rod, the vaporizer is electrically connected to the battery rod through the first input end and the second input end, an end of the heating element is connected to the first input end, the switch channel interface of the package is connected to the first input end, and another end of the heating element is connected to the ground interface of the package, so that the heating element and the control switch of the chip are respectively connected in parallel between the first input end and the second input end; and the communication interface of the package is connected to the first input end; and a capacitor, where the power supply interface of the package is grounded through the capacitor.

To resolve the foregoing technical problem, the third technical solution provided in this application is as follows: An electronic vaporization device is provided, including: a vaporizer, where the vaporizer is the vaporizer according to any one of the foregoing; and a battery rod, configured to supply power to the vaporizer.

### Beneficial Effects

The beneficial effects of this application are different from those in the prior art. In the chip for a vaporizer, the vaporizer, and the electronic vaporization device provided in this application, a package is arranged, and the package is provided with a communication interface, so that when the vaporizer is inserted in a battery rod, whether the battery rod communicates with the vaporizer is determined through the communication interface; when the battery rod communicates with the vaporizer, the vaporizer operates in a first mode; and when the battery rod does not communicate with the vaporizer, the vaporizer operates in a second mode. Therefore, the requirements of use of the vaporizer in different environments can be met.

The following clearly and completely describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

The following describes this application in detail with reference to the accompanying drawings and embodiments.

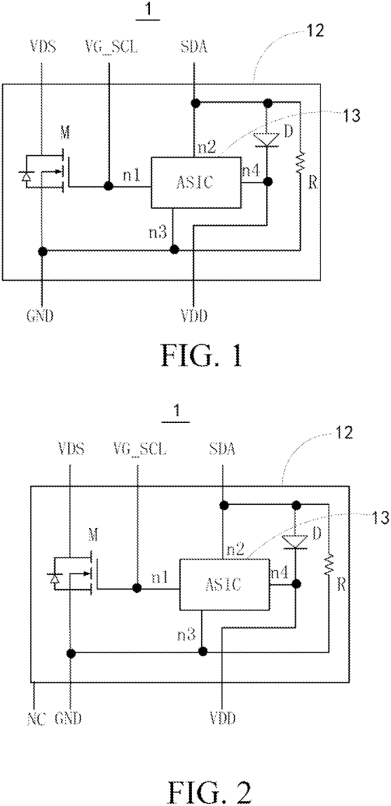

FIG. 1 is a schematic structural diagram of a first embodiment of a chip used for a vaporizer according to this application. Specifically, a chip 1 includes a package 12, where a communication interface SDA is provided on the package 12, and the communication interface SDA is configured to determine whether the battery rod can communicate with the vaporizer, when the vaporizer is inserted in a battery rod. When the battery rod communicates with the vaporizer, the vaporizer operates in a first mode; and when the battery rod fails to communicate with the vaporizer, the vaporizer operates in a second mode.

Specifically, the chip 1 further includes: a control switch M and a driving control circuit 13, where the control switch M and the driving control circuit 13 are both arranged in the package 12. A control end n1 of the driving control circuit 13 is connected to a control end of the control switch M, and a communication end n2 of the driving control circuit 13 is connected to the communication interface SDA, to determine whether the battery rod can communicate with the vaporizer through the communication interface SDA.

Specifically, the package 12 further includes a switch channel interface VDS, a ground interface GND and a power supply interface VDD. The switch channel interface VDS is connected to a first channel end of the control switch M; the ground interface GND is connected to a second channel end of the control switch M and a ground end n3 of the driving control circuit 13; and the power supply interface VDD is connected to a power supply end n4 of the driving control circuit 13, and is connected to the communication interface SDA.

The package 12 further includes a switch control interface VG_SCL, where the switch control interface VG_SCL is further connected to the control end of the control switch M.

Optionally, the chip 1 further includes: a diode D, arranged in the package 12, where the communication interface SDA is connected to the power supply interface VDD through the diode D. Specifically, the diode D is a diode, where an anode of the diode is connected to the communication interface SDA, and a cathode of the diode is connected to the power supply end n4 of the driving control circuit 13 and is connected to the power supply interface VDD. In an alternative embodiment, the diode D may also be a metal-oxide-semiconductor field effect transistor (MOSFET), a triode, and the like.

Optionally, the chip 1 further includes: a resistor R, arranged in the package 12, where the communication interface SDA is connected to the ground interface GND through the resistor R. Specifically, a first end of the resistor R is connected to the communication interface SDA, and a second end thereof is connected to the ground interface GND.

Optionally, the driving control circuit 13 further includes a memory, where preset data is stored in the memory. When the vaporizer is inserted in the battery rod and the battery rod does not communicate with the vaporizer within a preset time period, the driving control circuit 13 may control the control switch M according to the preset data or does not perform any operation, so that the vaporizer operates in the second mode.

Optionally, the driving control circuit 13 is an application-specific integrated circuit (ASIC). Further, the diode D may alternatively be integrated into the ASIC formed by the driving control circuit 13.

FIG. 2 is a schematic structural diagram of a first embodiment of a chip used for a vaporizer according to this application. Compared with the first embodiment shown in FIG. 1, a difference is that the chip 1 shown in this embodiment further includes: an expansion interface NC, where the expansion interface NC serves as a reserved interface of the chip 1. Optionally, the expansion interface NC is electrically connected to the ground interface GND in the package 12.

The chip 1 shown in FIG. 2 is packaged by using SOT23-6, while the chip 1 shown in FIG. 1 is packaged by using SOT23-5, which can reduce costs to the greatest extent in terms of package. However, using the SOT23-6 package manner shown in FIG. 2 is more favorable to internal wiring of the chip 1. In the chips 1 shown in FIG. 1 and FIG. 2, the first channel end, the second channel end, and the control end (corresponding to a drain, a source, and a gate respectively) of the control switch M are independently led out. In an actual application, a problem of insufficient current can be resolved by introducing an additional switch that is connected in parallel with the control switch M, and a problem of reverse conduction of the control switch M can be prevented by introducing an additional switch that is connected in series with the control switch M.

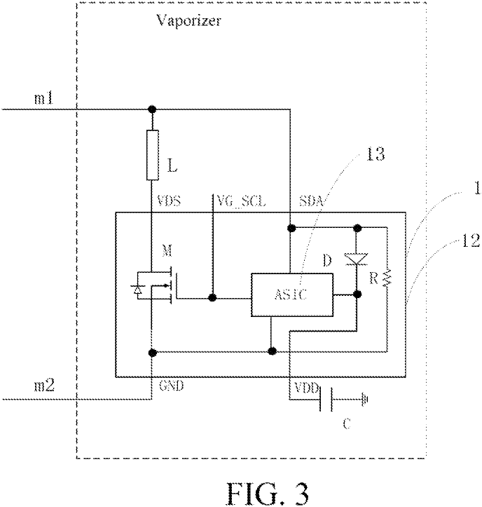

FIG. 3 is a schematic structural diagram of a first embodiment of a vaporizer according to this application. The vaporizer includes a heating element L and a chip 1. The chip 1 is connected to the heating element L, where the chip 1 is the chip 1 shown in any embodiment in FIG. 1 and FIG. 2.

After the vaporizer is inserted in a battery rod, when the battery rod communicates with the vaporizer, the chip 1 controls the heating element L to generate heat, so that the vaporizer operates in a first mode; and when the battery rod fails to communicate with the vaporizer, the chip 1 controls the heating element L to generate heat or to not generate heat, so that the vaporizer operates in a second mode. Specifically, in a specific embodiment, if the battery rod communicates with the vaporizer, it indicates that the vaporizer can match the battery rod, and the vaporizer and the battery rod are products of a same model and produced by a same manufacturer. In this case, the vaporizer may be controlled to generate heat according to the model of the vaporizer to operate in the first mode. If the battery rod fails to communicate with the vaporizer, it indicates that the vaporizer cannot match the battery rod, and the vaporizer and the battery rod are not products of a same model and produced by a same manufacturer. In this case, a default parameter may be used for controlling the vaporizer to generate heat or prohibiting the vaporizer from generating heat to cause the vaporizer to operate in the second mode.

Specifically, the vaporizer further includes: a first input end m1 and a second input end m2. When the vaporizer is inserted in the battery rod, the vaporizer is electrically connected to the battery rod through the first input end m1 and the second input end m2. In this embodiment, the heating element L and the control switch M of the chip 1 are connected in series between the first input end m1 and the second input end m2, and the communication interface SDA of the package 12 is connected to the first input end m1.

Optionally, the vaporizer further includes: a capacitor C, where the power supply interface VDD of the package 12 is grounded through the capacitor C.

Specifically, a first end of the heating element L is connected to the first input end m1, and a second end thereof is connected to the first channel end of the control switch M. A first end of the capacitor C is connected to the power supply interface VDD, and a second end thereof is grounded.

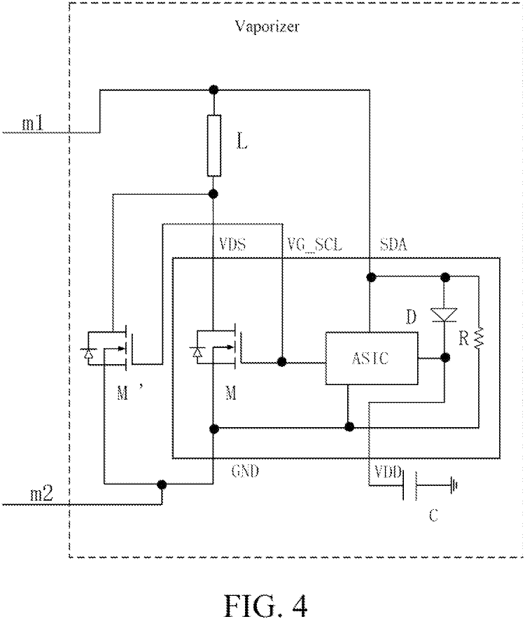

FIG. 4 is a schematic structural diagram of a second embodiment of a vaporizer according to this application. Compared with the first embodiment of the vaporizer shown in FIG. 3, a difference is that this embodiment further includes a first switch M′, and the first switch M′ and the control switch M are connected in parallel. Specifically, a control end of the first switch M′ is connected to a switch control interface VG_SCL, a first channel end of the first switch M′ is connected to the switch channel interface VDS and the first channel end of the control switch M, and a second channel end of the first switch M′ is connected to the ground interface GND and the second channel end of the control switch.

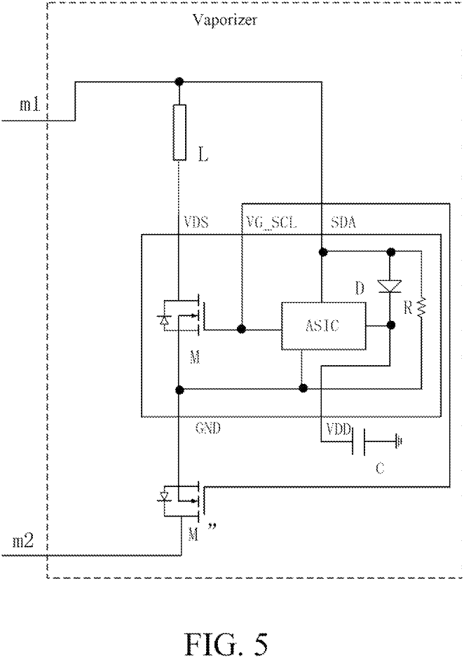

In this embodiment, the first switch M′ and the control switch M are connected in parallel, so that a conduction current is increased. For example, if a current that flows through the heating element L is 10 A, while the control switch M can only withstand a maximum current of 6 A, after completing an authentication operation, when the chip 1 turns on the control switch M and then uses a PWM signal to heat the heating element L, the control switch M cannot withstand the 10 A current, and an electronic vaporization device cannot vaporize normally. In this embodiment, since the expansion interface NC or the ground interface GND is reserved, the first switch M′ is externally connected, and the control switch M in the chip 1 and the first switch M′ are connected in parallel, so that the conduction current is increased. FIG. 5 is a schematic structural diagram of a third embodiment of a vaporizer according to this application. Compared with the first embodiment of the vaporizer shown in FIG. 3, a difference is that this embodiment further includes a second switch M″, where the second switch M″ and the control switch M are connected in series. Specifically, a control end of the second switch M″ is connected to the switch control interface VG_SCL, a first channel end of the second switch M″ is connected to the ground interface GND and the second channel end of the control switch M, and a second channel end of the second switch M″ is connected to the second input end m2. Specifically, in this embodiment, the heating element L, the control switch M, and the second switch M″ are connected in series between the first input end m1 and the second input end m2 in sequence.

In this embodiment, when only the control switch M exists in the chip 1, if the vaporizer is reversely inserted in the battery rod, the heating element L is grounded. When the second channel end (a source) of the control switch M is connected to the power supply voltage VDD, the power supply voltage VDD forms a channel through a body diode of the control switch M, so that reverse conduction is achieved. When only the second switch M″ exists in the chip 1, if the vaporizer is reversely inserted in the battery rod, a body diode of the second switch M″ is in a turn-off state, which can prevent the vaporizer from being damaged due to the reverse conduction of the vaporizer. Therefore, the heating element L, the control switch M, and the second switch M″ are connected in series between the first input end m1 and the second input end m2 in sequence, which can prevent a reverse conduction problem of the control switch M.

Operating modes of the vaporizers of the second embodiment and the third embodiment are similar to the operating mode of the vaporizer of the first embodiment. For brevity, details are not described herein again.

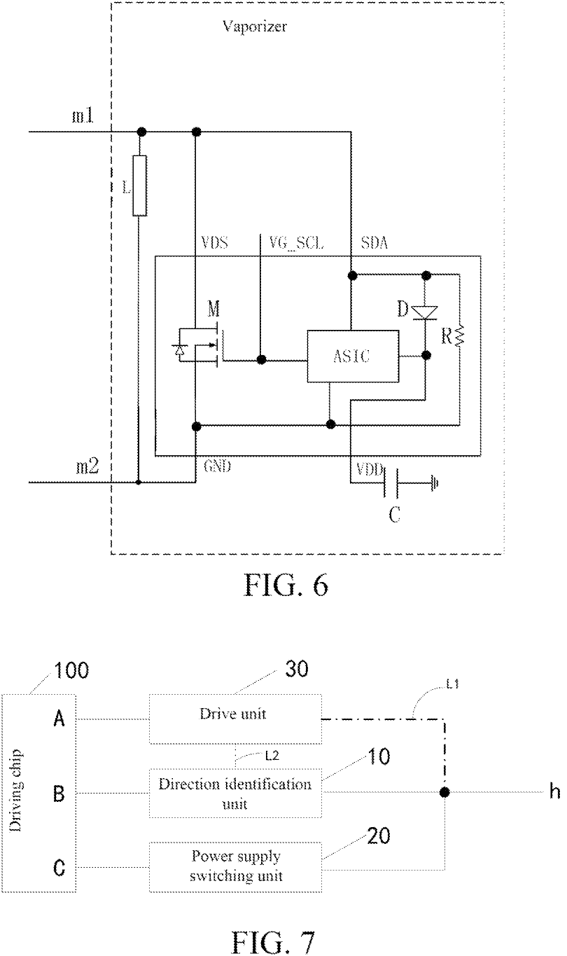

FIG. 6 is a schematic structural diagram of a fourth embodiment of a vaporizer according to this application. In this embodiment, the heating element L and the control switch M are connected in parallel between the first input end m1 and the second input end m2. Specifically, one end of the heating element L is connected to the first input end m1, the switch channel interface VDS of the package 12 is connected to the first input end m1, and the other end of the heating element L is connected to the ground interface GND of the package 12. In this embodiment, the communication interface SDA of the package 12 is connected to the first input end m1, and the capacitor C is connected to the power supply interface VDD of the package 12 and is grounded. Specifically, the first end of the capacitor C is connected to the power supply interface VDD, and the second end thereof is grounded. Specifically, the first channel end of the control switch M is connected to the first input end m1, the second channel end of the control switch M is connected to the second input end m2, and the control end of the control switch M is connected to the control end n1 of a driving control circuit 13.

In this embodiment, if the battery rod successfully communicates with the vaporizer, the battery rod may heat the heating element L according to a heating parameter stored in the vaporizer to cause the vaporizer to operate in the first mode. In this embodiment, since the heating element L and the control switch M are connected in parallel, if the battery rod fails to communicate with the vaporizer, provided that the battery rod sends a PWM signal, the heating element can still generate heat to cause the vaporizer to operate in the second mode. In this embodiment, the heating element L and the control switch M are connected in parallel, and the battery rod may determine whether the battery rod and the vaporizer are products produced by a same manufacturer by determining whether the battery rod and the vaporizer can communicate successfully, so as to identify the vaporizer, but cannot implement a function of prohibiting use of the vaporizer if the battery rod and the vaporizer do not match.

The chip used for the vaporizer according to this application may achieve a series connection between the heating element and the control switch, or achieve a parallel connection between the heating element and the control switch, and may implement different functions according to different software settings, so as to meet different usage requirements of the vaporizer in different usage environments.

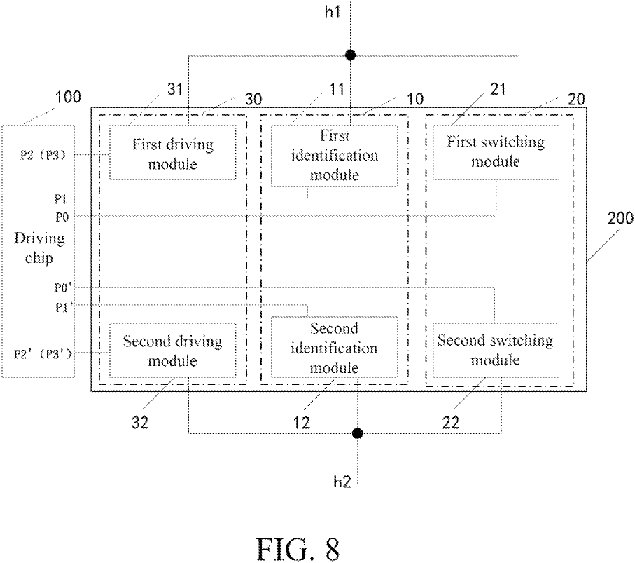

FIG. 7 is a schematic diagram of functional modules of a battery rod according to this application. The battery rod is configured to drive a vaporizer that is inserted therein and supply power to the vaporizer.

The battery rod includes: a driving chip 100 and a driving identification circuit 200 that is connected to the driving chip 100. When the vaporizer is inserted in the battery rod, the driving chip 100 determines that the vaporizer is forwardly inserted or reversely inserted through the driving identification circuit 200 and controls the driving identification circuit 200 to operate in a forward insertion mode or a reverse insertion mode.

Specifically, the driving identification circuit 200 includes: a direction identification unit 10, a driving unit 30, and a power supply switching unit 20; and the driving chip 100 includes: a detection communication port B, a driving port A, and a switching port C. The direction identification unit 10 is connected to the detection communication port B, the driving unit 30 is connected to the driving port A, and the power supply switching unit 20 is connected to the switching port C. The direction identification unit 10 and the power supply switching unit 20 are electrically connected to a connection pin h respectively; and the driving unit 30 is electrically connected to the connection pin h directly (such as the dash-dot line L1 shown in the figure) or is electrically connected to the connection pin h through the power supply switching unit 20 (such as the dashed line L2 shown in the figure).

The driving chip 100 determines that the vaporizer is forwardly inserted or reversely inserted through the detection communication port B and the direction identification unit 10, and controls the power supply switching unit 20 to switch through the switching port C, so that the driving identification circuit 200 operates in the forward insertion mode or the reverse insertion mode.

Specifically, referring to FIG. 8, FIG. 8 is a schematic diagram of functional modules of a specific embodiment of FIG. 7, where the detection communication port B includes a first detection communication port P1 and a second detection communication port P1′. The direction identification unit 10 includes: a first identification module 11 and a second identification module 12. The first identification module 11 is connected to the first detection communication port P1, and the second identification module 12 is connected to the second detection communication port P1′. In an embodiment, when it is determined that the first detection communication port P1 can communicate with the vaporizer, the vaporizer that is inserted in the battery rod is determined as being forwardly inserted; and when it is determined that the second detection communication port P1′ can communicate with the vaporizer, the vaporizer that is inserted in the battery rod is determined as being reversely inserted. Specifically, when the vaporizer is inserted in the battery rod, both the first detection communication port P1 and the second detection communication port P1′ of the battery rod send a string of data to the vaporizer. If the first detection communication port P1 detects a feedback signal, it indicates that the vaporizer that is inserted in the battery rod is forwardly inserted. If the second detection communication port P1′ detects the feedback signal, it indicates that the vaporizer that is inserted in the battery rod is reversely inserted.

The connection pin h further includes: a first connection pin h1 and a second connection pin h2, configured to be electrically connected to the vaporizer that is inserted in the battery rod. A description is made by using the vaporizer shown in the foregoing embodiment as an example. When the vaporizer that is inserted in the battery rod is forwardly inserted, the driving identification circuit 200 operates in the forward insertion mode, so that the first connection pin h1 serves as a power supply connection pin, and the second connection pin h2 serves as a ground voltage connection pin. In this case, the vaporizer is inserted in the battery rod, the first connection pin h1 is connected to the first input end m1, and the second connection pin h2 is connected to the second input end m2.

When the vaporizer that is inserted in the battery rod is reversely inserted, the driving identification circuit 200 operates in the reverse insertion mode, so that the first connection pin h1 serves as the ground voltage connection pin, and the second connection pin h2 serves as the power supply connection pin. In this case, the vaporizer is inserted in the battery rod, the first connection pin h1 is connected to the second input end m2, and the second connection pin h2 is connected to the first input end m1.

In another embodiment, the detection communication port B includes a first detection communication port P1 and a second detection communication port P1′. When it is determined that a resistance value collected by the first detection communication port P1 is a first preset range, and a resistance value collected by the second detection communication port P1′ is a second preset range, the vaporizer that is inserted in the battery rod is determined as being forwardly inserted. When it is determined that the resistance value collected by the first detection communication port P1 is the second preset range, and the resistance value collected by the second detection communication port P1′ is the first preset range, the vaporizer that is inserted in the battery rod is determined as being reversely inserted.

As shown in FIG. 8, in this embodiment, the driving port A includes a first group of driving ports P2 (P3) and a second group of driving ports P2′ (P3′). The driving unit 30 includes a first driving module 31 and a second driving module 32. The first driving module 31 is connected to the first group of driving ports P2 (P3), and the second driving module 32 is connected to the second group of driving ports P2′ (P3′).

The power supply switching unit 20 includes a first switching module 21 and a second switching module 22. The switching port C includes a first switching port P0 and a second switching port P0′. The first switching module 21 is connected to the first switching port P0, the first driving module 31, and the first connection pin h1. The second switching module 22 is connected to the second switching port P0′, the second driving module 32, and the second connection pin h2.

When the vaporizer that is inserted in the battery rod is forwardly inserted, the first switching port P0 and the second switching port P0′ switch the first switching module 21 to a non-operating mode and the second switching module 22 to an operating mode, so that the first connection pin h1 is connected to the first driving module 31, and the second connection pin h2 is connected to a ground voltage. When the vaporizer that is inserted in the battery rod is reversely inserted, the first switching port P0 and the second switching port P0′ switch the first switching module 21 to the operating mode and the second switching module 22 to the non-operating mode, so that the first connection pin h1 is connected to the ground voltage, and the second connection pin h2 is connected to the second driving module 32.

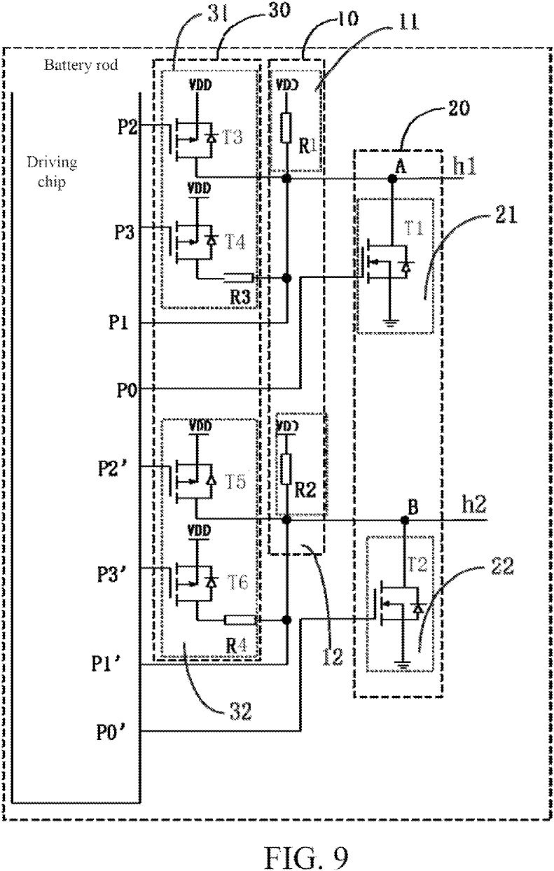

FIG. 9 is a schematic diagram of a specific structure of the functional modules shown in FIG. 8. Specifically, the first identification module 11 includes a first resistor R1, where a first end of the first resistor R1 is connected to the power supply voltage VDD, and a second end of the first resistor R1 is connected to the first detection communication port P1 and the first connection pin h1. The second identification module 12 includes a second resistor R2, where a first end of the second resistor R2 is connected to the power supply voltage VDD, and a second end of the second resistor R2 is connected to the second detection communication port P1′ and the second connection pin h2.

The first switching module 21 includes: a first switch T1, where a first channel end of the first switch T1 is connected to the first connection pin h1, a second channel end of the first switch T1 is connected to the ground voltage, and a control end of the first switch T1 is connected to the first switching port P0. The second switching module 22 includes: a second switch T2, where a first channel end of the second switch T2 is connected to the second connection pin h2, a second channel end of the second switch T2 is connected to the ground voltage, and a control end of the second switch T2 is connected to the second switching port P0′. When the vaporizer that is inserted in the battery rod is forwardly inserted, the first switching port P0 controls the first switch T1 to be turned off, and the second switching port P0′ controls the second switch T2 to be turned on, so that the second connection pin h2 is connected to the ground voltage. When the vaporizer that is inserted in the battery rod is reversely inserted, the first switching port P0 controls the first switch T1 to be turned on, so that the first connection pin h1 is connected to the ground voltage, and the second switching port P0′ controls the second switch T2 to be turned off.

The first group of driving ports P2 (P3) includes a first positive driving port P2 and a second positive driving port P3. The first driving module 31 includes: a third switch T3, a fourth switch T4, and a third resistor R3. A first channel end of the third switch T3 is connected to the power supply voltage VDD, a second channel end of the third switch T3 is connected to the first connection pin h1, and a control end of the third switch T3 is connected to the first positive driving port P2 A first channel end of the fourth switch T4 is connected to the power supply voltage VDD, and a control end of the fourth switch T4 is connected to the second positive driving port P3. A first end of the third resistor R3 is connected to a second channel end of the fourth switch T4, and a second end of the third resistor R3 is connected to the first detection communication port P1 and the first connection pin h1.

The second group of driving ports P2′ (P3′) includes a first negative driving port P2′ and a second negative driving port P3′. The second driving module 32 includes: a fifth switch T5, a sixth switch T6, and a fourth resistor R4. A first channel end of the fifth switch T5 is connected to the power supply voltage VDD, a second channel end of the fifth switch T5 is connected to the second connection pin h2, and a control end of the fifth switch T5 is connected to the first negative driving port P2′. A first channel end of the sixth switch T6 is connected to the power supply voltage VDD, and a control end of the sixth switch T6 is connected to the second negative driving port P3′. A first end of the fourth resistor R4 is connected to a second channel end of the sixth switch T6, and a second end of the fourth resistor R4 is connected to the second detection communication port P1′ and the second connection pin h2.

When the direction identification circuit 10 identifies that the vaporizer is forwardly inserted in the battery rod, the first positive driving port P2 and the second positive driving port P3 are used to control the third switch T3 and the fourth switch T4 to be turned on, thereby heating the heating element L. When the direction identification circuit 10 identifies that the vaporizer is reversely inserted in the battery rod, the first negative driving port P2′ and the second negative driving port P3′ are used to control the fifth switch T5 and the sixth switch T6 to be turned on, thereby heating the heating element L.

The battery rod shown in this embodiment can identify whether the inserted vaporizer is forwardly inserted or reversely inserted, and select a corresponding driving manner to drive the vaporizer according to an identification result, so that no matter the vaporizer is forwardly inserted or reversely inserted in the battery rod, the vaporizer may be driven by the battery rod to operate.

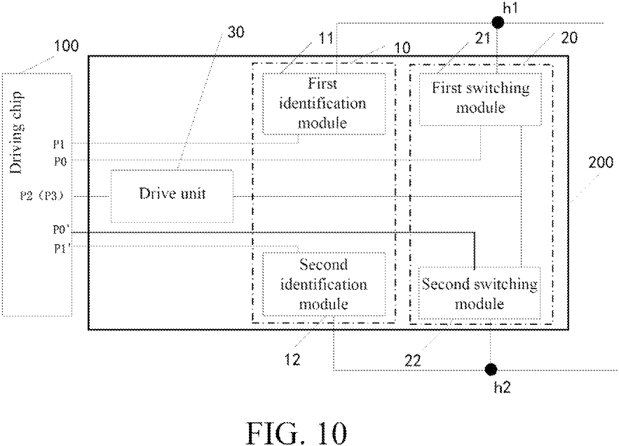

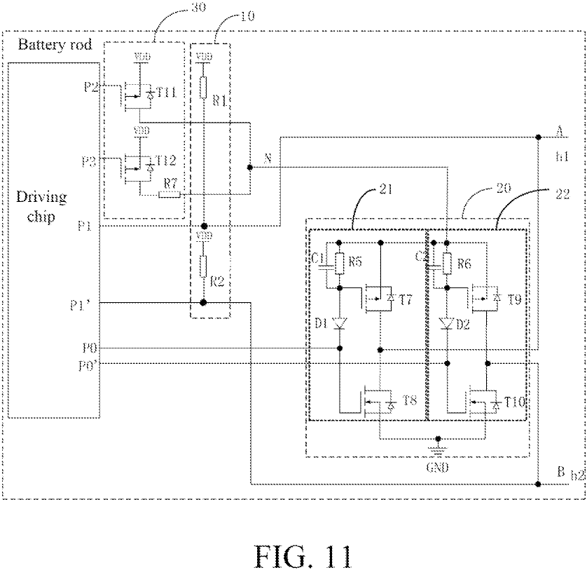

FIG. 10 is a schematic diagram of functional modules of another specific embodiment of FIG. 7. In this embodiment, the driving unit 30 only includes one driving module. Specifically, referring to FIG. 11, FIG. 11 is a specific schematic diagram of a specific structure of the function modules shown in FIG. 10. In this embodiment, the direction identification circuit 10 is the same as the direction identification circuit 10 in the battery rod shown in FIG. 9, and details are not described herein again. A difference between the direction identification circuit 10 in this embodiment and the direction identification circuit in the battery rod shown in FIG. 9 is that:

when the vaporizer that is inserted in the battery rod is forwardly inserted, the first switching port P0 and the second switching port P0′ switch the power supply switching unit 20 to operate in a first mode, so that the first connection pin h1 is connected to an output end N of the driving unit 30, and the second connection pin h2 is connected to the ground voltage GND.

When the vaporizer that is inserted in the battery rod is reversely inserted, the first switching port P0 and the second switching port P0′ switch the power supply switching unit 20 to operate in a second mode, so that the first connection pin h1 is connected to the ground voltage GND, and the second connection pin h2 is connected to the output end N of the driving unit 30.

Specifically, in this embodiment, the power supply switching unit 20 includes: a first switching module 21 and a second switching module 22. The first switching module 21 is connected to the first switching port P0 and the first connection pin h1, and is configured to be connected to the ground voltage GND, and the second switching module 22 is connected to the second switching port P0′ and the second connection pin h2, and is configured to be connected to the ground voltage GND. When the vaporizer that is inserted in the battery rod is forwardly inserted, the first switching port P0 switches the first switching module 31 to be connected to the output end N of the driving unit 30, and the second switching port P0′ switches the second switching module 22 to be connected to the ground voltage GND. When the vaporizer that is inserted in the battery rod is reversely inserted, the first switching port P0 switches the first switching module 31 to be connected to the ground voltage GND, and the second switching port P0′ switches the second switching module 22 to be connected to the output end N of the driving unit.

Specifically, as shown in FIG. 11, the first switching module 21 includes: a fifth resistor R5, a first capacitor C1, a first diode D1, a seventh switch T7, and an eighth switch T8. A first end of the fifth resistor R5 is connected to the output end N of the driving unit. A first end of the first capacitor C1 is connected to the output end N of the driving unit, and a second end of the first capacitor C1 is connected to a second end of the fifth resistor R5. A first end of the first diode D1 is connected to the second end of the fifth resistor R5, and a second end of the first diode D1 is connected to the first switching port P0. A first channel end of the seventh switch T7 is connected to the output end N of the driving unit, a second channel end of the seventh switch T7 is connected to the first connection pin h1, and a control end of the seventh switch T7 is connected to the second end of the fifth resistor R5. A first channel end of the eighth switch T8 is connected to the first connection pin h1, a second channel end of the eighth switch T8 is connected to the ground voltage GND, and a control end thereof is connected to the first switching port P0.

Specifically, the second switching module 22 includes: a sixth resistor R6, a second capacitor C2, a second diode D2, a ninth switch T9, and a tenth switch T10. A first end of the sixth resistor R6 is connected to the output end N of the driving unit. A first end of the second capacitor C2 is connected to the output end N of the driving unit, and a second end of the second capacitor C2 is connected to a second end of the sixth resistor R6. A first end of the second diode D2 is connected to the second end of the sixth resistor R6, and a second end of the second diode D2 is connected to the second switching port P0′. A first channel end of the ninth switch T9 is connected to the output end N of the driving unit, a second channel end of the ninth switch T9 is connected to the second connection pin h2, and a control end of the ninth switch T9 is connected to the second end of the sixth resistor R6. A first channel end of the tenth switch T10 is connected to the second connection pin h2, a second channel end of the tenth switch T10 is connected to the ground voltage GND, and a control end of the tenth switch T10 is connected to the second switching port P0′.

In this embodiment, the driving port A includes a first driving port P2 and a second driving port P3. The driving unit 30 includes: an eleventh switch T11, a twelfth switch T12, and a seventh resistor R7. A first channel end of the eleventh switch T11 is connected to the power supply voltage VDD, a second channel end of the eleventh switch T11 is connected to the output end N of the driving unit, and a control end of the eleventh switch T11 is connected to the first driving port P2. A first channel end of the twelfth switch T12 is connected to the power supply voltage VDD, and a control end of the twelfth switch T12 is connected to the second driving port P3. A first end of the seventh resistor R7 is connected to a second channel end of the twelfth switch T12, and a second end of the seventh resistor is connected to the output end N of the driving unit.

The direction identification circuit 10 shown in this embodiment is the same as the direction identification circuit 10 in the battery rod shown in FIG. 9, and details are not described herein again.

If the direction identification circuit 10 identifies that the vaporizer is forwardly inserted in the battery rod, the first switching port P0 outputs a low-level signal, so that the seventh switch M7 is turned on, and the first connection pin h1 is connected to the output end N of the driving circuit; and the second switching port P0′ outputs a high-level signal, so that the tenth switch T10 is turned on, the point B is grounded, and the second connection pin h2 is grounded.

If the direction identification circuit 10 identifies that the vaporizer is reversely inserted in the battery rod, the first switching port P0 outputs a high-level signal, so that the ninth switch M9 is turned on, and the second connection pin h2 is connected to the output end N of the driving circuit; and the second switching port P0′ outputs a low-level signal, so that the eighth switch T8 is turned on, the point A is grounded, and the first connection pin h1 is grounded.

In this embodiment, the first capacitor C1, the first diode D1, the fifth resistor R5 in the first switching module 21 and the second capacitor C2, the second diode D2, and the sixth resistor R6 in the second switching module 22 can ensure that the corresponding seventh switch T7 and the ninth switch T9 can be quickly turned on when the eleventh switch T11 is turned on, and ensure that the corresponding seventh switch T7 and the ninth switch T9 can continue to be in a turn-on state when the eleventh switch T11 is turned off.

When the vaporizer is forwardly inserted in the battery rod, the eleventh switch T11 outputs a PWM signal to supply power to the heating element L, and the first driving port P2 is at a low level, the eleventh switch T11 is turned on (equivalent to a high-level state of the PWM signal) to supply power to sources of the seventh switch T7 and the ninth switch T9. In this case, since the eighth switch T8 is turned off, a gate of the seventh switch T7 is clamped to the low level by the first diode D1 and the first switching port P0, thereby turning on the seventh switch T7. The first capacitor C1 is charged to a voltage difference ΔV between the gate and the source of the seventh switch T7, so that a current is connected to the first input end m1 of the vaporizer through the seventh switch T7, that is, the output end N of the driving circuit is input to the first input end m1 of the vaporizer. When the first driving port P2 is at a high level, the eleventh switch T11 is turned off (equivalent to a low level state of the PWM signal), and the source of the seventh switch T7 is pulled down to a low voltage by the heating element L. However, since the first capacitor C1 only has a discharging channel of the fifth resistor R5, a power failure of voltages on two ends of the first capacitor C1 does not occur quickly, so that the seventh switch T7 may be turned on continuously, that is, the output end N of the driving circuit is input to the first input end m1 of the vaporizer, so as to ensure that the twelfth switch T12 and a channel of the seventh resistor R7 may collect a parameter of the heating element L.

When the vaporizer is reversely inserted in the battery rod, the eleventh switch T11 outputs a PWM signal to supply power to the heating element L, and the first driving port P2 is at a low level, the eleventh switch T11 is turned on (equivalent to a high-level state of the PWM signal) to supply power to sources of the seventh switch T7 and the ninth switch T9. In this case, since the tenth switch T10 is turned off, a gate of the ninth switch T9 is clamped to the low level by the second diode D2 and the second switching port P0′, thereby turning on the ninth switch T9. The second capacitor C2 is charged to a voltage difference ΔV between the gate and the source of the ninth switch T9, so that a current is input to the second input end m2 of the vaporizer through the ninth switch T9, that is, the output end N of the driving circuit is input to the second input end m2 of the vaporizer. When the first driving port P2 is at a high level, the eleventh switch T11 is turned off (equivalent to a low-level state of the PWM signal), and the source of the ninth switch T9 is pulled down to a low voltage by the heating element L. However, since the second capacitor C2 only has a discharging channel of the sixth resistor R6, power failure of voltages on two ends of the second capacitor C2 does not occur quickly, so that the ninth switch T9 may be turned on continuously, that is, the output end N of the driving circuit is input to the second input end m2 of the vaporizer, thereby ensuring that the twelfth switch T12 and a channel of the seventh resistor R7 may collect a parameter of the heating element L.

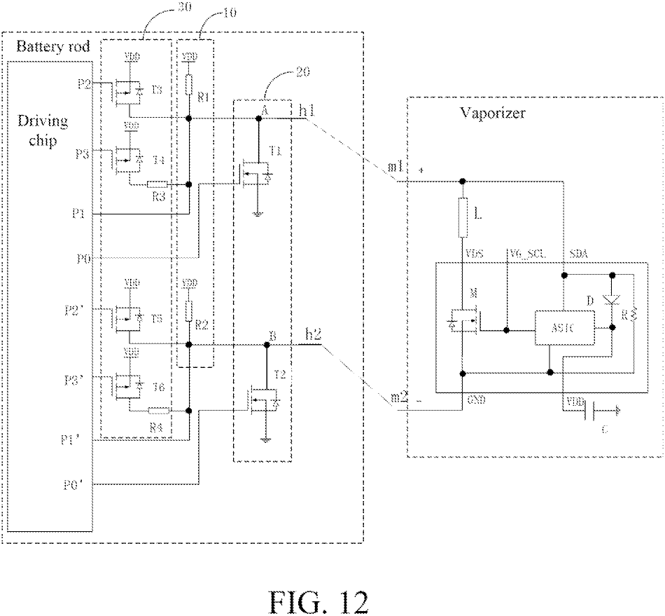

FIG. 12 is a schematic structural diagram of the vaporizer shown in FIG. 3 that is forwardly inserted in the battery rod shown in FIG. 9.

Specifically, the second switch T2 is set to be turned on. When the vaporizer is inserted in the battery rod, the first resistor R1 of the battery rod and the resistor R of the vaporizer divide the power supply voltage VDD, and the first detection communication port P1 detects a jump signal and further wakes up a driving chip MCU of the battery rod. In this case, the first detection communication port P1 and the second detection communication port P1′ of the driving chip 100 of the battery rod respectively send a series of data to the vaporizer through the first connection pin h1 and the second connection pin h2. If the first detection communication port P1 detects a feedback signal, it indicates that the vaporizer is forwardly inserted in the battery rod; and if the second detection communication port P1′ detects a feedback signal, it indicates that the vaporizer is reversely inserted in the battery rod.

Specifically, in another embodiment, when it is determined that a resistance value collected by the first detection communication port P1 is a first preset range, and a resistance value collected by the second detection communication port P1′ is a second preset range, the vaporizer that is inserted in the battery rod is determined as being forwardly inserted. Otherwise, the vaporizer is determined as being reversely inserted, that is, if the resistance value collected by the first detection communication port P1 is an internal resistance of the driving control circuit 13 (for example, greater than 3 kQ), and the resistance value collected by the second detection communication port P1′ is a resistance value of the heating element L (for example, less than 3 Ω), it indicates that the vaporizer is forwardly inserted in the battery rod; and if the resistance value collected by the first detection communication port P1 is the resistance value of the heating element L (for example, less than 3 Ω), and the resistance value collected by the second detection communication port P1′ is the internal resistance of the driving control circuit 13 (for example, greater than 3 kQ), it indicates that the vaporizer is reversely inserted in the battery rod.

In this embodiment, a description is made by using the vaporizer being forwardly inserted in the battery rod as an example. Specifically, the first connection pin h1 of the battery rod is connected to the first input end m1 of the vaporizer, and the second connection pin h2 of the battery rod is connected to the second input end m2 of the vaporizer. In addition, in this embodiment, the first switching port P0 controls the first switch T1 to be turned off, and the second switching port P0′ controls the second switch T2 to be turned off, so that the point B is connected to the ground voltage. In this case, the battery rod provides the power supply voltage VDD to the first input end m1 of the vaporizer through the first driving module 31, and further heats the heating element L.

FIG. 13 is a schematic structural diagram of the vaporizer shown in FIG. 3 that is reversely inserted in the battery rod shown in FIG. 9.

Specifically, the first switch T1 is set to be turned on. When the vaporizer is inserted in the battery rod, the second resistor R2 of the battery rod and the resistor R of the vaporizer divide the power supply voltage VDD, and the second detection communication port P1′ detects a jump signal and further wakes up a driving chip MCU of the battery rod. In this case, the first detection communication port P1 and the second detection communication port P1′ of the driving chip 100 of the battery rod respectively send a series of data to the vaporizer through the first connection pin h1 and the second connection pin h2. If the first detection communication port P1 detects a feedback signal, it indicates that the vaporizer is forwardly inserted in the battery rod; and if the second detection communication port P1′ detects a feedback signal, it indicates that the vaporizer is reversely inserted in the battery rod.

Specifically, in another embodiment, when it is determined that a resistance value collected by the first detection communication port P1 is a first preset range, and a resistance value collected by the second detection communication port P1′ is a second preset range, the vaporizer that is inserted in the battery rod is determined as being forwardly inserted. Otherwise, the vaporizer is determined as being reversely inserted, that is, if the resistance value collected by the first detection communication port P1 is an internal resistance of the driving control circuit 13 (for example, greater than 3 kΩ), and the resistance value collected by the second detection communication port P1′ is a resistance value of the heating element L (for example, less than 3 Ω), it indicates that the vaporizer is forwardly inserted in the battery rod; and if the resistance value collected by the first detection communication port P1 is the resistance value of the heating element L (for example, less than 3 Ω), and the resistance value collected by the second detection communication port P1′ is the internal resistance of the driving control circuit 13 (for example, greater than 3 kQ), it indicates that the vaporizer is reversely inserted in the battery rod.

In this embodiment, a description is made by using the vaporizer being forwardly inserted in the battery rod as an example. Specifically, the first connection pin h1 of the battery rod is connected to the second input end m2 of the vaporizer, and the second connection pin h2 of the battery rod is connected to the first input end m1 of the vaporizer. In addition, in this embodiment, the first switching port P0 controls the first switch T1 to be turned on, and the second switching port P0′ controls the second switch T2 to be turned off, so that the point A is connected to the ground voltage. In this case, the battery rod provides the power supply voltage VDD to the first input end m1 of the vaporizer through the second driving module 32, and then heats the heating element L.

For a specific operating principle of the vaporizer shown in FIG. 3 that is forwardly inserted or reversely inserted in the battery rod shown in FIG. 11, reference may be made to the foregoing descriptions, and details are not described herein again.

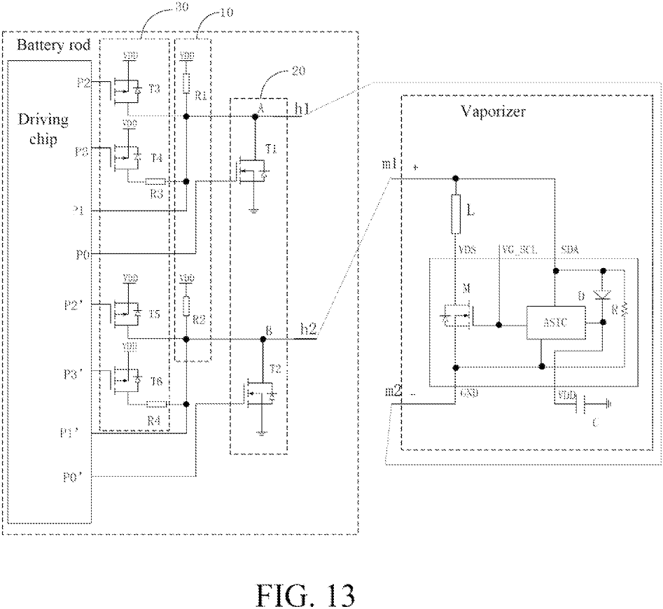

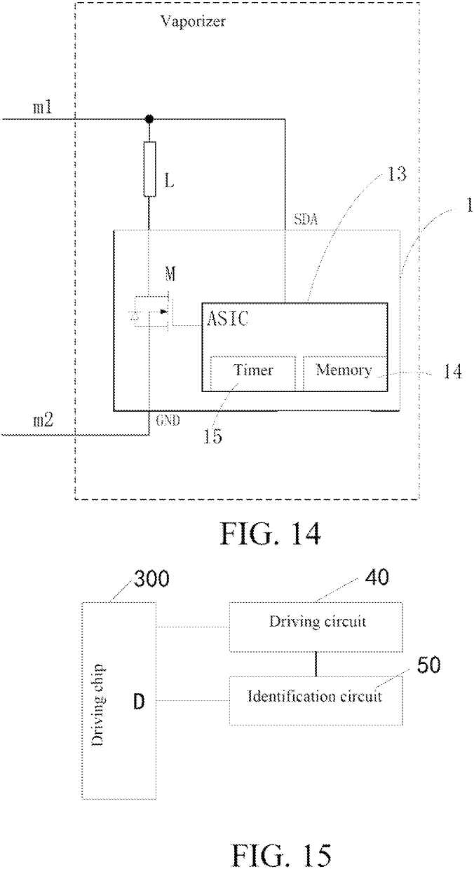

FIG. 14 is a schematic structural diagram of a fifth embodiment of a vaporizer according to this application; Specifically, compared with the vaporizer shown in FIG. 3, a memory 14 is further arranged in the chip 1. Specifically, the memory 14 is arranged in a driving control circuit 13. It should be noted that, for simplicity, the technical features shown in FIG. 3 are not fully shown in FIG. 14, and for the technical features not shown, reference can be directly made to the description in FIG. 3.

A scrap parameter is stored in the memory 14. The scrap parameter is used for identifying whether the vaporizer can be used. Specifically, if the scrap parameter stored in memory 14 is valid, it indicates that the vaporizer cannot be used; and if the scrap parameter stored in the memory 14 is invalid, it indicates that the vaporizer can be used.

Specifically, the communication interface SDA of the chip 1 communicates with the battery rod. Specifically, when the vaporizer is inserted in the battery rod, the vaporizer authenticates with the battery rod through the communication interface SDA. If the authentication is successful, the battery rod reads the scrap parameter stored in the memory 14 to determine whether the vaporizer can be used.

Specifically, when the vaporizer is inserted in the battery rod, the battery rod transmits data to the communication interface SDA of the vaporizer, and if the feedback data from the vaporizer is received, the authentication is successful. In this case, the battery rod reads the scrap parameter stored in the memory 14 of the vaporizer through the communication interface SDA.

Specifically, when the scrap parameter is in the valid state, the driving control circuit 13 controls the control switch M to be in an abnormal mode, so that the vaporizer cannot be used normally. Specifically, the driving control circuit 13 controls the control switch M to be disconnected. In this case, the battery rod cannot heat the heating element L, and the vaporizer cannot be used normally.

When the scrap parameter is in the invalid state, the driving control circuit 13 controls the control switch M to be in the normal mode, so that the vaporizer can be used normally. Specifically, the driving control circuit 13 controls the control switch M to be turned on. In this case, the battery rod heats the heating element L, and the vaporizer can be used normally.

Specifically, in an embodiment, the memory 14 includes a data protection area and a data read/write area, and the data read/write area stores a current inhalation parameter and the scrap parameter. The data protection area stores a default inhalation parameter and a default heating parameter. The default inhalation parameter, for example, can be the longest inhalation time or the maximum number of inhalations after oil injection of the vaporizer. The default heating parameter, for example, can be a corresponding heating power or a heating temperature curve. The current inhalation parameter, for example, can be the current inhalation time or the current number of inhalations of the vaporizer.

The vaporizer can be used when the scrap parameter is in the invalid state. The default heating parameter is obtained by the battery rod, and the battery rod heats the heating element L according to the default heating parameter, so that the vaporizer can be used normally. Specifically, when the battery rod heats the heating element L, the driving chip can control to output a corresponding heating power so that the heating element L can reach a predetermined temperature curve, to prevent overheating of the vaporization substrate.

In an embodiment, the driving control circuit 13 further includes a timer 15. When the vaporizer is in used normally, the driving control circuit 13 is controlled to turn off the control switch M at a predetermined interval time. Specifically, after the driving control circuit 13 controls the control switch M to be turned on, the control switch M is regularly controlled to be turned off every timed time of the timer. Alternatively, in another embodiment, a predetermined code is written in the driving control circuit 13, and the predetermined code can control the driving control circuit 13 to control the control switch M to be turned off every predetermined interval time.

In an embodiment, when it is detected that the vaporizer stops inhalation, the scrap parameter and the current inhalation parameter of the vaporizer are updated. If the updated current inhalation parameter reaches the default inhalation parameter, the scrap parameter in the vaporizer is updated to the valid state.

Specifically, a microphone or an airflow sensor is arranged in the battery rod. When the microphone or the airflow sensor detects passing of an airflow, the battery rod is awakened from a sleep state and transmits a conduction signal to the vaporizer. After the vaporizer receives a conduction instruction, the driving control circuit 13 controls the control switch M to be turned on, and then the battery rod obtains the default heating parameter to heat the heating element L, so that the vaporizer can be used normally. In this way, different vaporization substrates can be vaporized with different heating parameters to improve user experience. When the microphone or the airflow sensor detects stopping of the airflow, that is, when the inhalation is stopped, the battery rod stops heating the heating element L, and updates the current inhalation parameter in the vaporizer according to the inhalation time or the number of inhalations during the inhalation process. For example, when it is detected that the user stops sucking the electronic vaporization device, the battery rod accumulates the inhalation time or the number of inhalations and the inhalation time or the number of inhalations in the current inhalation parameter, and uses the accumulated result to update the current inhalation parameter.

Optionally, after updating the current inhalation parameter, the updated current inhalation parameter is compared with the default inhalation time, and when the updated current inhalation parameter reaches the default inhalation parameter, it indicates that the inhalation time or the number of inhalations of the vaporizer has been used up. In this case, the scrap parameter in the vaporizer is updated to the valid state to lock the vaporizer and prevent the vaporizer from being used. When the updated current inhalation parameter does not reach the default inhalation parameter, it indicates that the inhalation time or the number of inhalations of the vaporizer has not been used up, the battery rod enters the sleep time, and when the airflow is detected next time, continues to supply power to the vaporizer to heat the heating element L.

Further, If the scrap parameter of the vaporizer is updated to the valid state, the driving control circuit 13 controls the control switch M to be always in the off state, so as to prohibit the use of the vaporizer that the user injects oil without permission.

FIG. 15 is a schematic diagram of functional modules of a second embodiment of a battery rod according to this application. Specifically, a battery rod includes a driving chip 300, and the driving chip 300 is provided with a detection communication portion D. When a vaporizer is inserted in the battery rod, the detection communication portion D communicates with the vaporizer inserted in the battery rod, and reads a scrap parameter in the vaporizer to determine, according to the scrap parameter, whether the vaporizer can be used.

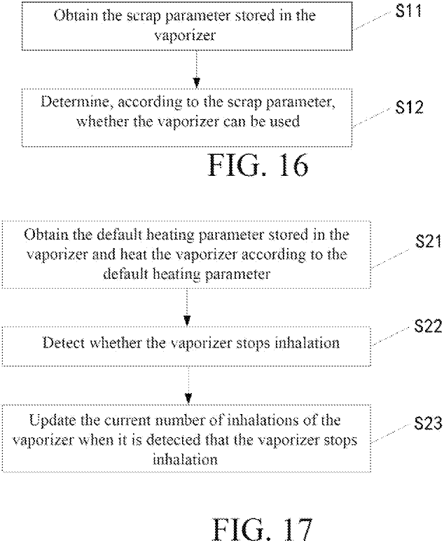

Specifically, FIG. 16 is a schematic flowchart of a method of using an electronic vaporization device according to an embodiment in this application. The electronic vaporization device includes the vaporizer in FIG. 14 and the battery rod in FIG. 15, and the method specifically includes:

Step S11: Obtain the scrap parameter stored in the vaporizer.

Specifically, the memory 14 is arranged in the vaporizer, and the memory 14 stores the scrap parameter. When the vaporizer is inserted in the battery rod, the battery rod performs communication authentication with the communication interface SDA of the vaporizer through the detection communication portion D. If the authentication is successful, the battery rod reads the scrap parameter. Specifically, the battery rod further includes: an identification circuit 50, and the detection communication portion D communicates with the vaporizer through the identification circuit 50.

Step S12: Determine, according to the scrap parameter, whether the vaporizer can be used.

Specifically, when the read scrap parameter is invalid, it indicates that the vaporizer can be used, and when the read scrap parameter is valid, it indicates that the vaporizer cannot be used.

Referring to FIG. 17, the method further includes:

Step S21: Obtain the default heating parameter stored in the vaporizer and heat the vaporizer according to the default heating parameter.

Specifically, When the read scrap parameter is invalid, it indicates that the vaporizer can be used, and the battery rod obtains the default heating parameter stored in the memory 14 of the vaporizer and heats the vaporizer according to the default heating parameter. In a specific embodiment, the default inhalation parameter, for example, can be the longest inhalation time or the maximum number of inhalations after the oil injection of the vaporizer. The default heating parameter, for example, can be a corresponding heating power or a heating temperature curve.

Specifically, the battery rod further includes: a drive circuit 40, and the drive circuit 40 is connected to the driving chip 300 and the identification circuit 50. When the read scrap parameter is invalid, the battery rod obtains the default heating parameter stored in the vaporizer, and uses the drive circuit 40 to heat the heating element L of the vaporizer according to the default heating parameter, so that the vaporizer can be used normally.

In a specific embodiment, the driving chip 300 is the driving chip 100 shown in FIG. 9, the detection communication portion D of the driving chip 300 is the first detection communication portion P1 or the second detection communication portion P1′ of the driving chip 100, the identification circuit 50 is the first identification module 11 or the second identification module 12 shown in FIG. 9, and the drive circuit 40 is the first drive module 31 or the second drive module 32 shown in FIG. 9. The circuit connection of the detection communication portion D, the identification circuit 50, the drive circuit 40, and the driving chip 300 is the same as the circuit connection of the first detection communication portion P1, the first identification module 11, the first drive module 31, and the driving chip 100 shown in FIG. 9 or the circuit connection of the second detection communication portion P1′, the second identification module 12, the second drive module 32, and the driving chip 100.

It can be understood that, in other embodiments, the electronic vaporization device may also include the battery rod shown in FIG. 9. In this case, before step S11, the method further includes the step: Identify whether the vaporizer is forwardly or reversely inserted and select the corresponding detection communication portion, drive module, and identification module. It can be understood that, in other embodiments, the electronic vaporization device may also include the battery rod shown in FIG. 11, and its specific operating process is similar, which will not be repeated here.

Step S22: Detect whether the vaporizer stops inhalation.

Specifically, a microphone or an airflow sensor is arranged in the battery rod. When the microphone or the airflow sensor detects passing of an airflow, the battery rod is awakened from a sleep state and transmits a conduction signal to the vaporizer. After the vaporizer receives a conduction instruction, the driving control circuit 13 controls the control switch M to be turned on, and then the battery rod obtains the default heating parameter to heat the heating element L, so that the vaporizer can be used normally. When the microphone or the airflow sensor detects no passing of an airflow, the vaporizer stops inhalation.

Step S23: Update the current number of inhalations of the vaporizer and the scrap parameter when it is detected that the vaporizer stops inhalation.

When the microphone or the airflow sensor detects no passing of an airflow, the vaporizer stops inhalation, and the battery rod stops heating the heating element L, and updates the current inhalation parameter in the vaporizer according to the inhalation time or the number of inhalations during the inhalation process. For example, when it is detected that the user stops sucking the electronic vaporization device, the battery rod accumulates the inhalation time or the number of inhalations and the inhalation time or the number of inhalations in the current inhalation parameter, and uses the accumulated result to update the current inhalation parameter.

Optionally, after updating the current inhalation parameter, the updated current inhalation parameter is compared with the default inhalation time, and when the updated current inhalation parameter reaches the default inhalation parameter, it indicates that the inhalation time or the number of inhalations of the vaporizer is used up. In this case, the scrap parameter in the vaporizer is updated to the valid state to lock the vaporizer and prevent the vaporizer from being used. When the updated current inhalation parameter does not reach the default inhalation parameter, it indicates that the inhalation time or the number of inhalations of the vaporizer has not been used up, the battery rod enters the sleep time, and when the airflow is detected next time, continues to supply power to the vaporizer to heat the heating element L.

Further, If the scrap parameter of the vaporizer is updated to the valid state, the driving control circuit 13 controls the control switch M to be always in the off state, so as to prohibit the use of the vaporizer that the user injects oil without permission.

This application provides an electronic vaporization device, where a chip is arranged in a vaporizer, and the vaporizer can communicate with a battery rod through a communication interface arranged on the chip. When the battery rod communicates with the vaporizer, the vaporizer operates in a first mode; and when the battery rod does not communicate with the vaporizer, the vaporizer operates in a second mode. Specifically, if the battery rod communicates with the vaporizer, it indicates that the battery rod and the vaporizer are products from the same manufacturer; and if the battery rod does not communicate with the vaporizer, it indicates that the battery rod and the vaporizer are not products from the same manufacturer. Through the method of this application, the battery rod and the vaporizer of the same model or different models operate in different modes, so as to meet the requirements of use in different environments.

In the electronic vaporization device provided in this application, a driving chip and a drive identification circuit are arranged in the battery rod, and the drive identification circuit is connected to the driving chip. When the vaporizer is inserted in the battery rod, the driving chip determines that the vaporizer is inserted forwardly or reversely through the drive identification circuit and controls the drive identification circuit to operate in a forward insertion mode or a reverse insertion mode. This enables the battery rod and the vaporizer to operate normally in both the forward insertion mode and the reverse insertion mode.

The electronic vaporization device in this application can also prevent the use of the vaporizer that the user injects oil without permission.

The foregoing descriptions are merely implementations of this application but are not intended to limit the patent scope of this application. Any equivalent structural or equivalent process change made by using the content of the specification and the accompanying drawings of this application for direct or indirect use in other relevant technical fields shall fall within the patent protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A chip for a vaporizer, comprising:
a package comprising a communication interface configured to determine whether a battery rod into which the vaporizer is inserted communicates with the vaporizer,
wherein, when the battery rod communicates with the vaporizer, the vaporizer is configured to operate in a first mode, and
wherein, when the battery rod does not communicate with the vaporizer, the vaporizer is configured to operate in a second mode.

2. The chip of claim 1, further comprising:
a control switch arranged in the package; and
a driving control circuit arranged in the package, a control end of the driving control circuit being connected to a control end of the control switch, and a communication end of the driving control circuit being connected to the communication interface and configured to determine whether the battery rod communicates with the vaporizer through the communication interface.

3. The chip of claim 2, wherein the package further comprises:
a switch channel interface;
a ground interface; and
a power supply interface,
wherein the switch channel interface is connected to a first channel end of the control switch,
wherein the ground interface is connected to a second channel end of the control switch and a ground end of the driving control circuit, and
wherein the power supply interface is connected to a power supply end of the driving control circuit and connected to the communication interface.

4. The chip of claim 3, wherein the package further comprises:
a switch control interface and/or an expansion interface,
wherein the switch control interface is connected to the control end of the control switch, and the expansion interface comprises a reserved interface of the chip.

5. The chip of claim 3, further comprising:
a diode arranged in the package,
wherein the communication interface is connected to the power supply interface through the diode.

6. The chip of claim 3, further comprising:
a resistor arranged in the package,
wherein the communication interface is connected to the ground interface through the resistor.

7. The chip of claim 3, wherein the driving control circuit comprises a memory storing preset data,
wherein, when the vaporizer is inserted in the battery rod and the battery rod does not communicate with the vaporizer within a predetermined time period, the driving control circuit is configured to control the control switch of the preset data so to cause the vaporizer to operate in the second mode.

8. A vaporizer, comprising:
a heating element; and
the chip of claim 1 connected to the heating element,
where, after the vaporizer is inserted in the battery rod, when the battery rod communicates with the vaporizer, the chip is configured to control the heating element so as to cause the vaporizer to operate in the first mode, and
wherein, when the battery rod does not communicate with the vaporizer, the chip is configured to control the heating element to cause the vaporizer to operate in the second mode.

9. The vaporizer of claim 8, further comprising:
a first input end; and
a second input end,
wherein, when the vaporizer is inserted in the battery rod, the vaporizer is electrically connected to the battery rod through the first input end and the second input end, the heating element and the control switch of the chip are connected in series between the first input end and the second input end, and the communication interface of the package is connected to the first input end, and
wherein the vaporizer further comprises a capacitor, the power supply interface of the package being grounded through the capacitor.

10. The vaporizer of claim 9, further comprising:
a first switch, a control end of the first switch being connected to the switch control interface, a first channel end of the first switch being connected to the switch channel interface, and a second channel end of the first switch being connected to the ground interface such that the first switch is connected in parallel to the control switch.

11. The vaporizer of claim 9, further comprising:
a second switch, a control end of the second switch being connected to the switch control interface, a first channel end of the second switch being connected to the ground interface, and a second channel end of the second switch being connected to the second input end such that the heating element, the control switch, and the second switch are connected in series between the first input end and the second input end in sequence.

12. The vaporizer of claim 8, further comprising:
a first input end and a second input end,
wherein, when the vaporizer is inserted in the battery rod, the vaporizer is electrically connected to the battery rod through the first input end and the second input end, an end of the heating element is connected to the first input end, the switch channel interface of the package is connected to the first input end, and an other end of the heating element is connected to the ground interface of the package such that the heating element and the control switch of the chip are respectively connected in parallel between the first input end and the second input end and the communication interface of the package is connected to the first input end, and
wherein the vaporizer further comprises a capacitor, the power supply interface of the package being grounded through the capacitor.

13. An electronic vaporization device, comprising:
the vaporizer of claim 8; and
a battery rod configured to supply power to the vaporizer.
